(19) United States
(12) Patent Application Publication
(10) Pub. No.: US 2005/0026480 A1
(43) Pub. Date: Feb. 3, 2005

(54) Ground joint connector

(75) Inventors: Masayasu Fujii, Mie (JP); Toshiki Hayashi, Mie (JP); Toshikazu Sakurai, Mie (JP); Shigeki Takahashi, Saitama (JP)

Correspondence Address: OLIFF & BERRIDGE, PLC, P.O. BOX 19928, ALEXANDRIA, VA, 22320, US

(73) Assignees: SUMITOMO WIRING SYSTEMS, LTD., YOKKAICHI-SHI (JP); HONDA MOTOR CO., LTD., TOKYO (JP)

(21) Appl. No.: 10/729,900

(22) Filed: Dec. 9, 2003

(30) Foreign Application Priority Data
Dec. 12, 2002 (JP) P2002-360616

(51) Int. Cl. H01R 4/66

(52) U.S. Cl. 439/108

(57) ABSTRACT

Four fitting recessed portions 15A to 15D are provided in a connector housing 11, and four separate mating connectors in which ground wires are introduced, respectively, are allowed to be fitted into the fitting recessed portions so provided, respectively. A ground terminal 20 is formed by folding an elongate bus bar 21 in a plurality of stages, and each stage is formed into a configuration in which a plurality of tabs 23 are provided in a straight line along one or both edges of the bus bar 21. The ground terminal 20 is installed with tabs 23 being arranged so as to face the respective fitting recessed portions 15A to 15D and an ground plate 25 being made to protrude outwardly.

### BACKGROUND OF THE INVENTION

1. Field of the Invention

The present invention relates to a ground joint connector.

2. Description of the Related Art

A connector disclosed in JP-A-6-084565 has been known as an example of a conventional ground joint connector. The ground joint connector has a structure in which a grounding portion is provided at an end portion of a connector housing which has connecting portions provided therein for fittingly receiving therein mating connectors. The ground joint connector also has a grounding terminal including a plurality of terminal pieces which are provided on the grounding terminal in such a manner as to protrude therefrom and which are connected to the grounding portion is installed in the connector housing in such a manner that the respective terminal pieces are made to face the connecting portions. The grounding portion is fixed onto a grounding member such as a vehicle body, and thereafter, the mating connectors which are connected to ends of ground wires are fitted in the corresponding connecting portions, whereby the ground wires are grounded together.

In recent years, there have been introduced a wide variety of electric components for installing in automotive vehicles. In conjunction with this tendency, there is emerging a trend that the numbers of wiring harness circuits and hence ground circuits are increasing. Here, as long as ground joint connectors are used to get electric components grounded, in order to meet the increase in the number of ground circuits so used, it can be conceived to increase the number of poles in the ground joint connector.

On the other hand, when considering a job of laying out wiring harnesses in a vehicle body assembling process, it is also true with the preparation of ground wires for assembly that in the event that ground wires are divided into a plurality of groups according to the order of assembly to the vehicle body, it can facilitate the performance of such a process of laying out ground wires. Therefore, in view of the way of preparing ground wires by dividing them into the plurality of groups according to the order of assembly, it has been an approach adopted to deal with the increase in the number of ground circuits so used to increase the number of ground joint connectors rather than increasing the number of poles in a ground joint connector.

In the event that the number of ground joint connectors is increased, however, a process of fixing a grounding portion of a ground terminal to a grounding member with a fastener needs to be carried out repeatedly so many times as the number of ground joint connectors so provided, and therefore, it may cause a certain complexity in the assembling process.

### SUMMARY OF THE INVENTION

It is therefore an object of the invention to overcome the problems described above.

In order to achieve the object, according to one aspect of the invention, there is provided a ground joint connector including: a connector housing; a plurality of connecting portions disposed in the connector housing and configured to be fitted with respective mating connectors; and a ground terminal installed in the connector housing and having a common grounding portion and a plurality of terminal pieces connected to the common grounding portion, wherein the plurality of terminal pieces are arranged to be protruded into the plurality of connecting portions respectively, and wherein the common grounding portion is arranged to be protruded outward from the connector housing.

### BRIEF DESCRIPTION OF THE DRAWINGS

The objects and advantages of the present invention will become more apparent by describing a preferred embodiment thereof in detail with reference to the accompanying drawings, wherein:

FIG. 1 is a plan view showing a ground joint connector according to an embodiment of the invention together with mating connectors;

FIG. 2 is a drawing to show a rear view of the ground joint connector and a front view of a first connector;

FIG. 3 is a front view showing second to fourth connectors;

FIG. 4 is a side view showing the ground joint connector and the mating connectors;

FIG. 5 is a cross-sectional view taken along the line V-V in FIG. 3 which shows a state before the mating connector is fitted into the ground joint connector; and

FIG. 6 is a cross-sectional view taken along the line VI-VI in FIG. 3.

### DETAILED DESCRIPTION OF THE PREFERRED EMBODIMENTS

Referring now to the accompanying drawings, a description will be given in detail of a preferred embodiment of the invention.

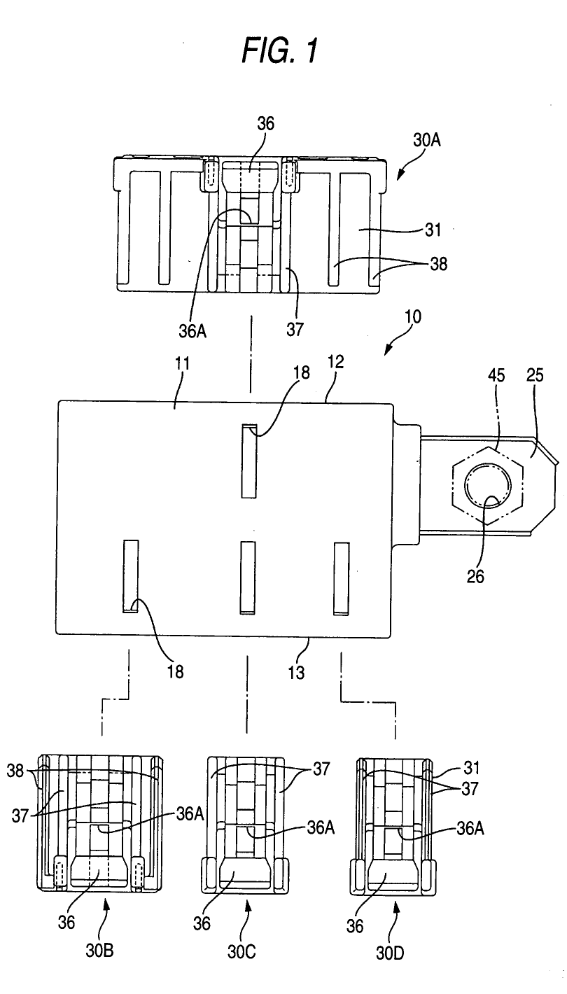

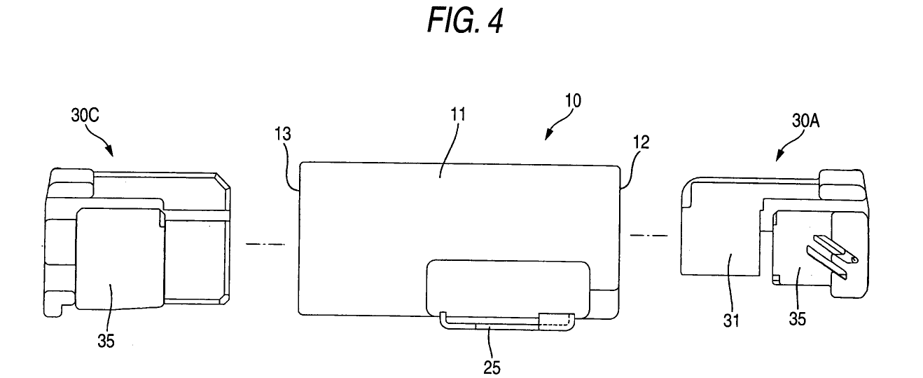

The preferred embodiment of the invention will be described below with reference to FIGS. 1 through 6.

In FIG. 1, reference numeral 10 denotes a ground joint connector according to the invention, in which four mating connectors in total are designed to be fitted therein on two opposite sides thereof.

Specifically, the mating connectors include a first connector 30A which is large in size and which is fitted in one side of the ground joint connector 10 and three, that is, second, third and fourth connectors 30B, 30C, 30D which are small in size and which are fitted in the other side of the same connector.

Since, while being different from one another in size, the first to fourth connectors 30A to 30D are basically identical in construction, to represent them, the first connector 30A will be described below.

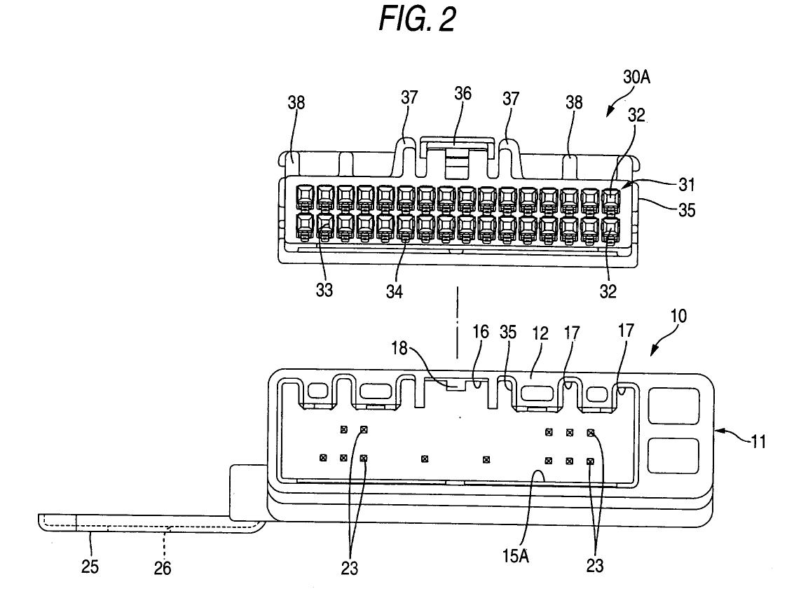

The first connector 30A has a female connector housing 31 made from a synthetic resin, and as shown in FIGS. 2 through 5, the housing 31 is formed into a block-shape configuration having a transversely elongated cross section, in which a plurality of cavities 32 which are each made to face longitudinally are formed in two stages. A terminal insertion opening 33 is made to open in a front side of each cavity 32 so that a tab (terminal pieces) 23 of a ground terminal 20, which will be described later, is inserted thereinto.

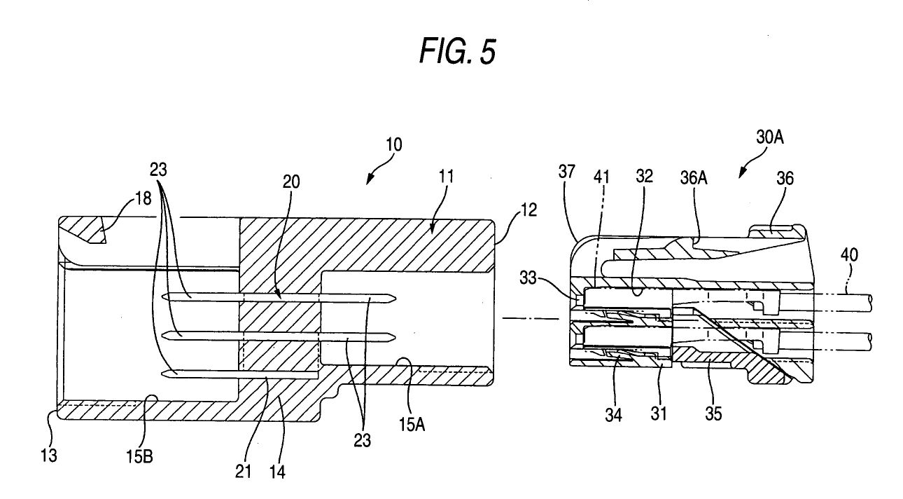

A female terminal 41 fixedly attached to an end of an ground wire 40 is inserted into each cavity 32 from the rear (a right-hand side in FIG. 5) so as to be accommodated therein while being be locked firstly by a lance 34 provided on a bottom side of the cavity 32 and secondarily by a retainer 35. Note that among the cavities 32, there are some so-called vacant cavities into which no female terminal 41 is inserted.

A lock arm 36 is provided at a transversely central portion on a top side of the housing 31 in such a manner as to be held between a pair of left and right protection walls 37, and a rib 38 is provided to erect at appropriate positions to prevent the insertion of the connector from a reverse direction.

In addition, since the second to fourth connectors 30B to 30D are different from the first connector 30A only in size and number of stages where the cavities 32 are provided, like reference numerals are given to locations having like functions to those of the first connector 30A, and the description thereof will be briefly made or omitted.

The ground joint connector 10 has a connector housing 11 made from the same synthetic resin. This connector housing 11 is formed into a flat block-shape configuration and is provided on two opposing sides thereof with fitting surfaces 12, 13 into which mating connectors are fitted.

As shown in FIG. 2, a single first fitting recessed portion (connecting portion) 15A is formed in the fitting surface 12 thereof into which the first connector 30A can be fitted. A groove 16 and grooves 17 are formed in a ceiling side of the first fitting recessed portion 15 into which the lock arm 36, and the protection walls 37 and the ribs 38 which are formed on the housing 31 of the first connector 30A are inserted, respectively. In addition, as shown in FIG. 5 for reference, a locking protruding portion 18 is formed in the groove 16 into which the lock arm 36 is inserted so as to be fitted in a locking hole 36A formed in the lock arm 36.

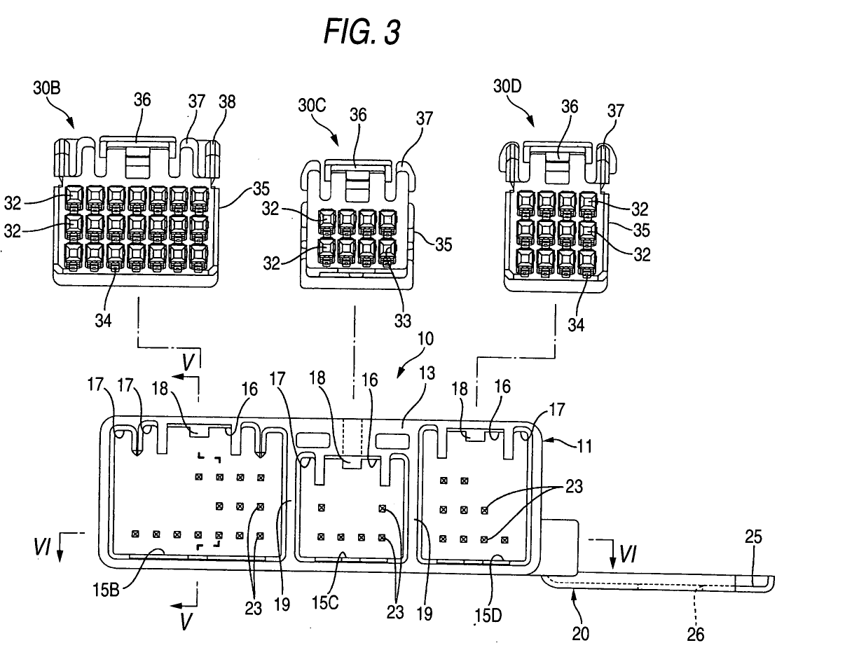

As shown in FIG. 3, three, second, third and fourth fitting recessed portions (connecting portions) 15B, 15C, 15D are formed transversely in a straight line in such a manner as to be partitioned by partition walls 19, so that the second to fourth connectors 30B to 30D can be fitted into the respective fitting recessed portions 15B to 15D individually.

A groove 16 and grooves 17 are formed on a ceiling side of each of the second to fourth fitting recessed portions 15B to 15D into which a lock arm 36, and protection walls 37 and ribs 38 which are provided on each of the second to fourth connectors 30B to 30D are inserted, respectively. In addition, a locking protruding portion 18 is formed in the groove 16 into which the lock arm 36 is inserted so as to be fitted in a locking hole 36A formed in the lock arm 36.

In addition, a thick intermediate wall 14 is formed between a deeper or rear side of the first fitting recessed portion 15A and deeper or rear sides of the second to fourth fitting recessed portions 15B to 15D.

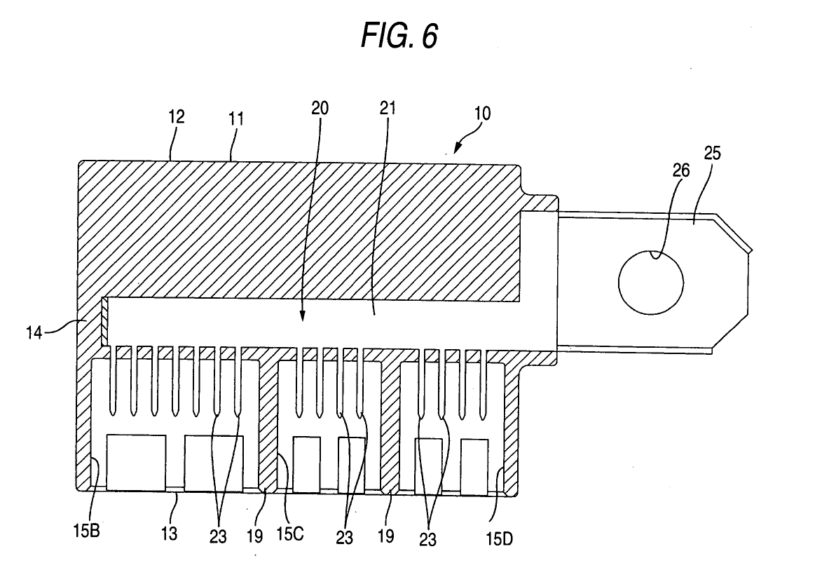

The ground terminal 20 is installed in the connector housing 11. The ground terminal 20 is formed by folding an elongate bus bar 21 in three folds or stages, and a plurality of tabs 23 are provided on the bus bar 21 placed at a lowermost stage in such a manner as to protrude in an aligned fashion from an edge thereof which is located on a side facing the viewer in FIG. 6, whereas on the bus bars 21 placed at uppermost and middle stages tabs 23 are provided to protrude from both edges. In addition, a wide ground plate (common grounding portion) 25 having a mounting hole 26 formed therein is formed integrally at a free end of the lowest bus bar 21 in such a manner as to be lowered by a step from the bus bar 21.

The ground terminal 20 is installed inside the connector housing 11 using insert molding. To be specific, the bus bar 21 which continues in the three-staged fashion is embedded in the intermediate wall 14, and the ground plate 25 is made to protrude outwardly from a lower portion of a side of the connector housing 11 at a position closer to the fitting surface 12, which is one of the fitting surfaces.

In addition, in the first fitting recessed portion 15A, the tabs 23 are made to protrude from the deepest side of the first fitting recessed portion 15A into the interior thereof in two stages. On the other side of the bus bar 21, the tabs 23 are made to protrude from the deepest sides of the second and fourth fitting recessed portions 15B, 15D in three stages, whereas in the third fitting recessed portion 15C, the tabs 23 are made to protrude from the deepest side thereof in two stages.

An example of a usage of the ground joint connector 10 according to the invention will be described as below.

Firstly, the first connector 30A is fitted into the first fitting recessed portion 15A, and the locking protruding portion 18 is fitted into the locking hole 36 in the lock arm 36, whereby the first connector 30A is locked in the first fitting recessed portion 15A. The female terminal 41 accommodated in the first connector 30A is fitted on the corresponding tab 23 protruding from the deepest side of the first fitting recessed portion 15A for connection therewith.

In addition, the second to fourth connectors 30B to 30D are sequentially fitted into the three, second to fourth fitting recessed portions 15B to 15D in the opposite fitting surface 13 and are locked, respectively, in a similar fashion to that in which the first connector 30A is locked. In conjunction with the locking of the second to fourth connectors 30B to 30D, female terminals 41 accommodated in the respective connectors 30B to 30D are fitted on the corresponding tabs 23 protruding from the deepest sides of the respective fitting recessed portions 15B to 15D for connection therewith.

Finally, the ground plate 25 of the ground terminal 20 is fastened and fixed to the grounding member such as the vehicle body with a bolt 45 (refer to FIG. 1).

Thus, the female terminals 41 accommodated in the respective mating connectors 30A to 30D and hence the ground wires 40 connected to the female terminals 41 are grounded together.

As has been described heretofore, according to the embodiment of the invention, since the four fitting recessed portions 15A to 15D are provided so as to individually fit into the four separate mating connectors 30A to 30D with the single ground terminal 20 being provided to be shared by the respective fitting recessed portions 15A to 15D, the job of fixing the ground plate 25 of the ground terminal 20 to the grounding member such as the vehicle body only has to be carried out once while retaining the advantage of handling the plurality of ground wires 40 which are divided into groups, thereby making it possible to attempt to improve the working efficiency.

The invention is not limited to the embodiment that has been described above by reference to the accompanying drawings, but the following embodiments may fall within the technical scope of the invention, and moreover, it will be apparent that the invention may be further modified in various ways without departing from the spirit and scope thereof.

(1) The arrangement of the tabs in the ground terminal can be set in any way according to applications.

(2) The number of connectors in which ground wires are arranged may be two or larger as required.

(3) The order of assembly may be set as required, such as an order in which the earth connector is fitted in the mating connectors in advance, and the ground plate is finally attached to a metallic panel.

Although the present invention has been shown and described with reference to specific embodiments, various changes and modifications will be apparent to those skilled in the art from the teachings herein. Such changes and modifications as are obvious are deemed to come within the spirit, scope and contemplation of the invention as defined in the appended claims.

1. A ground joint connector comprising:
a connector housing;
a plurality of connecting portions disposed in the connector housing and configured to be fitted with respective mating connectors; and
a ground terminal installed in the connector housing and having a common grounding portion and a plurality of terminal pieces connected to the common grounding portion,
wherein the plurality of terminal pieces are arranged to be protruded into the plurality of connecting portions respectively, and
wherein the common grounding portion is arranged to be protruded outward from the connector housing.

2. The ground joint connector as claimed in claim 1, wherein the plurality of connecting portions are arranged in a straight line.

3. The ground joint connector as claimed in claim 2, wherein the ground terminal further has a bus bar extended in a direction as same as the direction of the arrangement of the plurality of connecting portions, and
wherein the plurality of terminal pieces are protruded from one side of the bus bar.
